(19) United States
(12) Patent Application Publication
(10) Pub. No.: US 2011/0303136 A1
(43) Pub. Date: Dec. 15, 2011

(54) REVERSIBLE JAMB BLOCKS AND METHOD OF USING THE SAME

(75) Inventor: John M. Peterman, Weldon Spring, MO (US)

(73) Assignee: GILLESPIE + POWERS, INC., St. Louis, MO (US)

(21) Appl. No.: 13/156,560

(22) Filed: Jun. 9, 2011

Related U.S. Application Data
(60) Provisional application No. 61/353,354, filed on Jun. 10, 2010.

(51) Int. Cl. F27D 1/00

(52) U.S. Cl. 110/341; 110/173 R

(57) ABSTRACT

A reversible jamb block for a furnace, oven or kiln, having an attachment side adapted to removably attach to the first side of a doorway for the furnace, oven or kiln, and adapted to removably attach to the second side of the doorway, such that one face of the jamb block is directed away from the furnace when the attachment side of the jamb block is attached to the first side of the doorway, and a second face opposite the first face, is directed away from the furnace when the attachment side of the jamb block is attached to the second side of the doorway.

### CROSS REFERENCE TO RELATED APPLICATIONS

This application derives and claims priority from U.S. provisional application 61/353,354 filed 10 Jun. 2010, which application is incorporated herein by reference.

### STATEMENT REGARDING FEDERALLY SPONSORED RESEARCH OR DEVELOPMENT

Not applicable.

### BACKGROUND OF THE INVENTION

This invention relates principally to a high temperature oven, furnace or kiln, and more particularly to a unique reversible jamb block for the sides of a door for a high temperature oven, furnace or kiln.

When a high temperature oven, furnace or kiln is constructed, the device will typically incorporate one or more doors to allow access to various areas within the body of the oven, furnace or kiln. In most cases, the door will be constructed of steel or some other rigid and temperature resistant metal, and may have refractory material or some other high temperature insulation material attached to or surrounding the metal to provide additional heat resistance. Such doors fit into specially configured door frames designed to receive the doors and minimize the amount of heat that may escape between the door and the door frame.

However, high temperature oven, furnace or kiln doors and door frames are exposed to very harsh environmental conditions. They must retain integrity at very high temperatures while in the presence of various gases that may include highly volatile and caustic chemical such as, for example, oxygen, carbon and sulfur compounds, and various forms and combinations of grit. In addition, such doors are typically very heavy and unwieldy, and it is therefore not uncommon for the operation of the doors to impart substantial vibration, shock and impact loads on the doors and the door frames. As a result, the doors and door frames degrade and must be replaced on a regular basis. It is desirable, therefore, that the door frames be built to withstand such abuses while providing a reasonable cycle lifetime.

One common component of such door frames is a replaceable door jamb block. These replaceable jamb blocks are vertical pillars positioned on each side of the door frame against which the edges of the door rests when closed. Traditionally, the doors and door frames are constructed of heavy materials such as steels and ceramics, and are configured such that the door rests at an angle against the door frame with the upper end of the door leaning inward towards the body of the oven, furnace or kiln. The traditional replaceable jamb blocks, in turn, comprise an outward directed face that is sloped to receive the edges of the door in a flush manner. Anchor bolts are used to secure the jamb blocks to the side of the opening in the doorway. The traditional replaceable jamb blocks are, therefore, trapezoidal in shape.

The outside faces of the traditional jamb blocks wear out due to several factors. Impact damage from service equipment, door movement abrasions, and door impact. The movement of the door is two fold. First, the door moves vertically against the doorway and abrades the jamb block surfaces. Second, the door moves in and out against the doorway and impacts the jamb block surfaces. Often, the door is suspended and atop the jamb blocks and acts as a heavy and abrasive pendulum during the operation of the kiln.

In contrast, the inside faces of the jamb blocks are protected from the conditions that damage the front faces, because the inside faces are traditionally encased in and protected by the refractory walls of the kiln. In addition, expansion material, normally a high temperature crushable block refractory, is often used to separate the kiln's inside refractory wall from the inside face of the jamb blocks. This allows the kiln's refractory walls to expand toward the jamb blocks without damage to the inner face of the jamb blocks.

Nonetheless, once the front faces of traditional jamb blocks degrade to an unacceptable level, the blocks must be replaced. It is desirable, therefore, to devise a jamb block that has a longer service life than traditional configurations.

As will become evident in this disclosure, the present invention provides benefits over the existing art.

### BRIEF DESCRIPTION OF THE DRAWINGS

The illustrative embodiments of the present invention are shown in the following drawings which form a part of the specification:

FIG. 1 is a perspective view of a reversible jamb block incorporating one embodiment of the present invention;

FIG. 2 is a side view of the reversible jamb block of FIG. 1;

FIG. 3 is an edge view of the reversible jamb block of FIG. 1;

FIG. 4 is a top view of the reversible jamb block of FIG. 1;

FIG. 5 is a perspective view of four reversible jamb blocks of FIG. 1 arranged in pairs in a stacked configuration for attachment to both sides of a kiln doorway;

FIG. 6 is a perspective view of the four reversible jamb blocks of FIG. 5 arranged in pairs in a stacked configuration and attached to the sides of a kiln doorway;

FIG. 7 is a perspective view of the four reversible jamb blocks of FIG. 5 arranged in pairs in a stacked configuration and attached to the sides of a kiln doorway, with a kiln door positioned against the front face of the jamb blocks;

FIG. 8 is a perspective view of a pair of the reversible jamb blocks of FIG. 1 arranged in a doorway of a kiln, and depicting the reversible attribute of the jamb block;

FIG. 9 is a perspective view of the reversible jamb blocks of FIG. 8 arranged in the kiln doorway after having been reversed;

FIG. 10 is a perspective view of an alternate configuration of the reversible jamb block of the present invention, depicting the interface between the jamb block and the pegged side plate of a kiln doorway;

FIG. 11 is a perspective view of the reversible jamb block of FIG. 10 in relation to two opposing pegged side plates of a kiln doorway, depicting the reversible attribute of the jamb block;

Corresponding reference characters indicate corresponding parts throughout the several views of the drawings.

### DETAILED DESCRIPTION

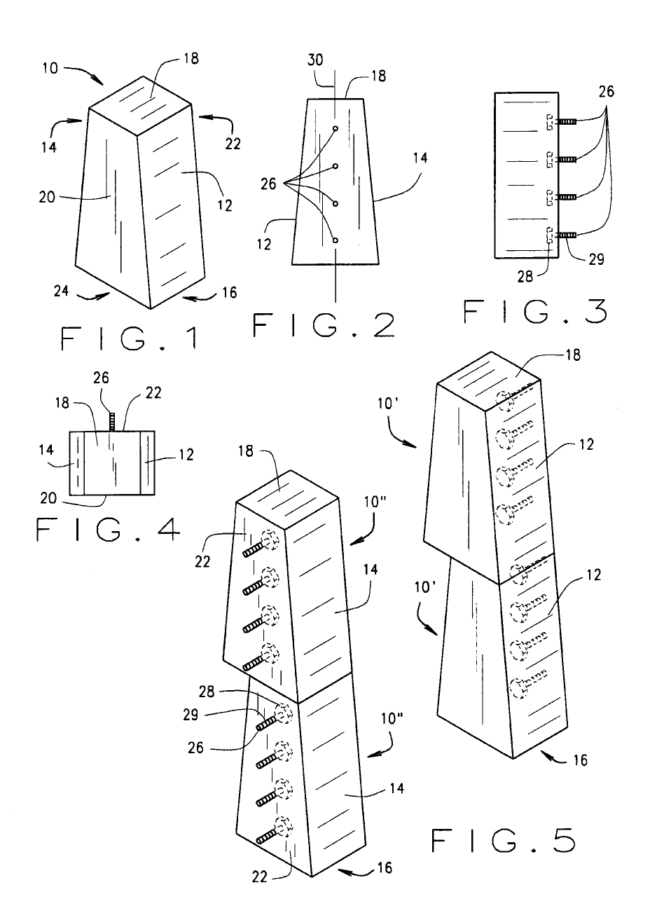

In referring to the drawings, an embodiment of the novel reversible jamb block 10 for a furnace, oven or kiln (collectively hereinafter “kiln”) of the present invention is shown generally in FIGS. 1-4, where the present invention is depicted by way of example. As can be seen, the jamb block 10 has a flat first face 12, a flat second face 14 opposite the first face 12, a flat base 16 and a flat top 18 opposite and parallel to the base 16. The jamb block 10 further has a flat first attachment side 20 and a flat second attachment side 22 opposite and substantially parallel to the first side 20. When viewed from either of the first or second sides 20 or 22, the perimeter of the jamb block 10 forms an isosceles trapezoid. The jamb block 10 has a body 24 defined by the faces 12 and 14, the base 16, the top 18 and the first and second attachment sides 20 and 22. The jamb block 10 is symmetrical about a vertical center plane 30 (FIG. 2) that bisects the jamb block 10.

The body 24 of the jamb block 10 is comprised of a material that is rigid, and composed to withstand exposure to the high and low temperature extremes and hostile gaseous and particulate environment found at the doorway of a kiln. The particular material that may be used is somewhat dependent upon the specific application. However, such material is typically one or more of a variety of refractory ceramics. The jamb block material must also be strong and durable enough to withstand the repeated opening and closing of a heavy metal door.

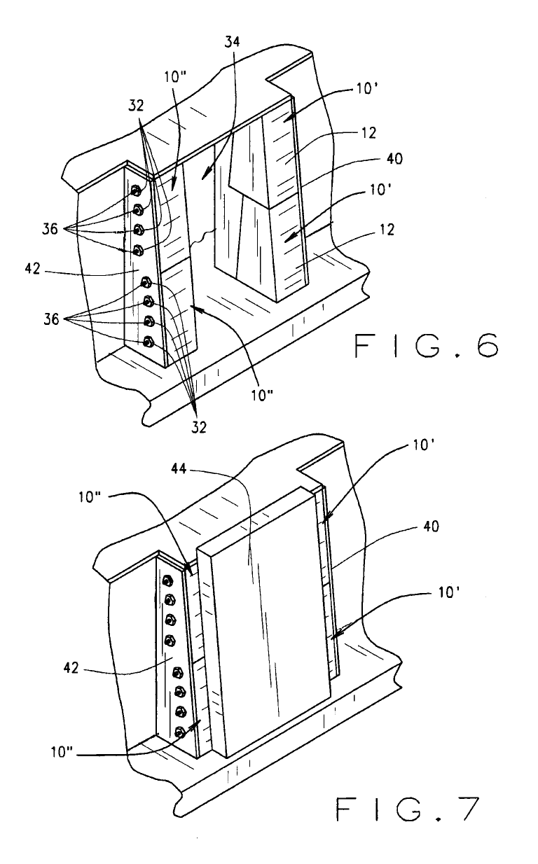

The jamb block 10 also comprises four steel anchor bolts 26, each having a hexagonal head 28 and a threaded end 29. (FIGS. 2, 3, 4). The anchor bolts 26 are imbedded headfirst in the body 24 of the jamb block 10 through the second attachment side 22 and are all equidistant from one another along the plane 30. The heads 28 are held fast in the body 24 and the treaded ends 29 protrude out of the body 24 perpendicular to the second attachment side 22. In this way, the anchor bolts 26 are unable to rotate in the body 24. The anchor bolts 26 are positioned to mate with and penetrate matching anchor bolt holes 32 (see FIG. 6) along right and left metal side plates 40 and 42 of a doorway 34 for a kiln so that nuts 36 sized to fit the threaded ends 29 of the anchor bolts 26 can be used to secure the jamb block to the side plates 40 and 42 of the doorway 34. A door 44 (see FIG. 7) can be positioned against the outward facing faces of the jamb blocks 10′ and 10″. The door 44 may be placed in the doorway 34 in a variety of ways, including for example, manually, with rollers, using springs, using guides, on hinges, or any of a variety of other ways well known to one of ordinary skill in the art. Often times, a door 44 will be held in place with pressure from a weight or a biasing mechanism (not shown).

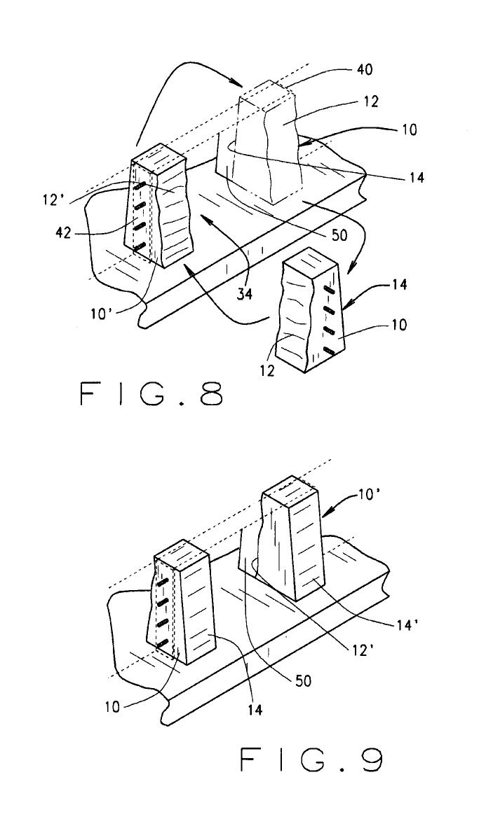

Referring now to FIGS. 8 and 9, and as can be appreciated by one of ordinary skill in the art, when initially installed in a doorway 34 for a kiln, a pair of the novel jamb blocks 10 and 10′ may be secured to the doorway 34 with the first of the jamb blocks 10 secured to the right side plate 40 and the opposite jamb block 10′ secured to the left side plate 42 as shown. In this way, the first faces 12 and 12′ of the blocks 10 and 10′ are directed outward and away from the kiln. The opposing faces 14 and 14′ are thereby directed toward the kiln where they mate with and are protected by the inner wall 50 of the kiln. When the first faces 12 and 12′ of the jamb blocks 10 and 10′ reach an unacceptable degree of degradation, as depicted in FIGS. 8 and 9, or are otherwise damaged or in need of replacement, the jamb block 10 can be removed from the right side of the kiln doorway 34, rotated 180 degrees about its central vertical axis, and secured to the left side of the kiln doorway 34 with the face 12 directed toward the kiln inner wall 50 and the face 14 directed away from the kiln. At the same time, the jamb block 10′ can be removed from the left side of the kiln doorway 34, rotated 180 degrees about its central vertical axis, and secured to the right side of the kiln doorway 34 with the face 12′ directed toward the kiln inner wall 50 and the with the face 14′ directed away from the kiln. The blocks 10 and 10′ may then be secured to the doorway 34 with the nuts 36 as previously discussed. In this way, and as shown in FIG. 9, the degraded faces 12 and 12′ are now directed toward or into the kiln doorway 34, and the fresh and undamaged faces 14 and 14′ are now directed away from the kiln doorway, and ready to receive the door 44.

Of course, alternatively, the jamb block 10 may initially be secured to the left side plate 42 with the face 14 directed outward and away from the inner wall 50, and the jamb block 10′ will then initially be secured to the right side plate 40 with the face 14′ directed outward and away from the inner wall 50. In this instance, when jamb block replacement is desired, the jamb block 10 is removed from the left side plate 42 of the kiln doorway 34, rotated 180 degrees about its central vertical axis, and secured to the right side plate 40 of the kiln doorway 34 with the first face 12 directed outward and away from the kiln inner wall 50, while the jamb block 10′ is removed from the right side plate 40 of the kiln doorway 34, rotated 180 degrees about its central vertical axis, and secured to the left side plate 42 of the kiln doorway 34 with the first face 12′ directed outward and away from the kiln inner wall 50.

Hence, the novel configuration of the current inventive jamb block 10 may provide approximately twice the service life of a traditional jamb block. In addition, only a single configuration of jamb block 10 is required for each kiln doorway, instead of conventional designs that require a different jamb block for each side of the doorway 34.

Moreover, the novel jamb block 10 is configured so that it may be stacked in a vertical manner to accommodate kiln doorways of varying heights. In the example shown in FIG. 5, two sets of paired jamb blocks 10′ and 10″ are arranged such that two of the jamb blocks 10′ are positioned with anchor bolts 26 facing to the right and the other two of the jamb blocks 10″ are positioned with anchor bolts 26 facing to the left. The right side jamb blocks 10′ are arranged with one of the jamb blocks 10′ stacked atop the other such that the base 16 of the upper jamb block 10′ rests atop the top 18 of the lower jamb block 10′, and the first faces 12 of both jamb blocks 10′ are coplanar. In this way, the first faces 12 of the jamb blocks 10′ are both directed away from the kiln, and present a single sloped surface to receive the right side of the door 44 to the kiln. Likewise, the left side jamb blocks 10″ are arranged with one of the jamb blocks 10″ stacked atop the other such that the base 16 of the upper jamb block 10″ rests atop the top 18 of the lower jamb block 10″, and the second faces 14 of both jamb blocks 10″ are coplanar. In this way, the second faces 14 of the jamb blocks 10″ are both directed away from the kiln, and present a single sloped surface to receive the left side of the door 44 to the kiln.

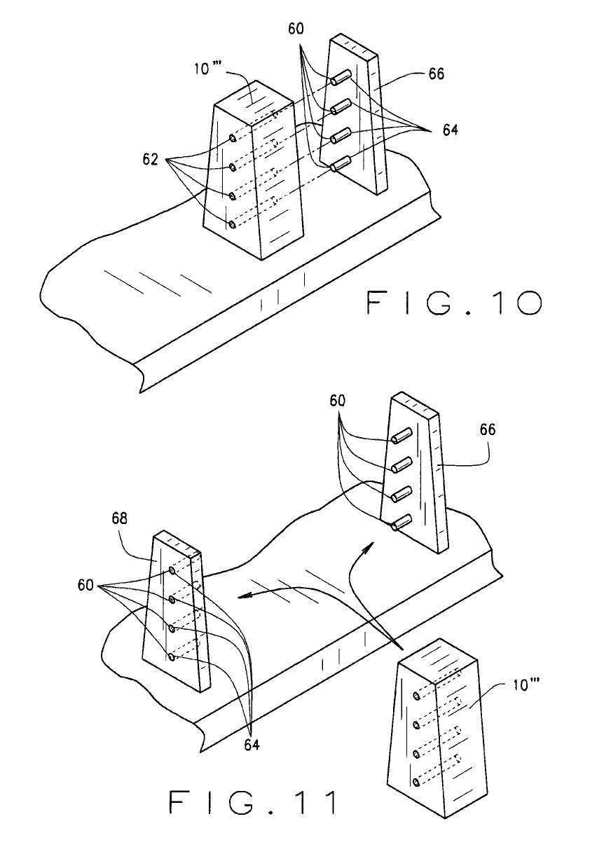

In yet another embodiment (FIGS. 10, 11), the novel jamb block 10′″ may alternatively be configured with removable anchor bolts or pegs 60 that are configured to fit into matching bores 62 in the block 10′″ and simultaneously into matching bores 64 of a side plate 66 of the doorway 34. As can be appreciated, the novel jamb block 10′″ can be readily secured to the side plate 66 using the bolts or pegs 50 for alignment and retention. Thereafter, the block 10′″ can readily be removed, rotated 180 degrees about its central vertical axis, and placed back against the side plate 66 or placed against the side plate 68 on the other side of the doorway 34 (FIG. 11). Alternatively, the bolts or pegs 60 could be fixed in place in the side plates 66 and 68.

While I have described in the detailed description several configurations that may be encompassed within the disclosed embodiments of this invention, numerous other alternative configurations, that would now be apparent to one of ordinary skill in the art, may be designed and constructed within the bounds of my invention as set forth in the claims. Moreover, each of the above-described novel reversible jamb blocks 10, 10′, 10″ and 10′″ of the present invention can be arranged in a number of other and related varieties of configurations without expanding beyond the scope of my invention as set forth in the claims.

For example, instead of anchor bolts 26, the jamb block 10 may alternately comprise any of a variety of attachment devices such as for example, hooks, screws, latches, clamps, pegs, pins, etc., so long as the attachment devices adequately secure the jamb block 10 to the kiln doorway as needed for the particular application. Further, the blocks 10 are not restricted to using any particular number of the bolts 26, but may use as many or as few as may be required to adequately secure the blocks 10 to the doorway 34. In addition, the bolts 26 can be arranged in patterns other than a single row along the central plane 30, so long as the block 10 can be rotated about a vertical axis such that the bolts 26 can mate to reciprocal bores 32 on the opposing side of the doorway 34. Moreover, the body 24 of the jamb block 10 may be configured to engage the kiln doorway such that the anchor bolts 26 may be unnecessary. This engagement may be interlocking, such as for example a tongue and groove configuration.

With regard to stacking, the jamb blocks 10, 10′ and 10″ may be of a variety of heights, widths and thicknesses in order to accommodate a myriad of configurations of kiln doorways. Further, the jamb blocks 10, 10′ and 10″ may be configured to stack more than two high.

Additional variations or modifications to the configuration of the novel reversible jamb block 10 of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. A reversible jamb block for a furnace having a doorway with a first side and a second side opposite the first side, the jamb block comprising:
a. a first attachment side adapted to removably attach to the first side of the doorway and adapted to removably attach to the second side of the doorway;
b. a first face that is directed away from the furnace when the first attachment side of the jamb block is attached to the first side of the doorway; and
c. a second face opposite the first face, the second face directed away from the furnace when the first attachment side of the jamb block is attached to the second side of the doorway.

2. The jamb block of claim 1, wherein the first face of the jamb block is configured to receive a first edge of a door when the first attachment side of the jamb block is attached to the first side of the doorway, and wherein the second face is configured to receive a second edge of the door when the first attachment side of the jamb block is attached to the second side of the doorway.

3. The jamb block of claim 1, wherein said jamb block is bilaterally symmetric.

4. The jamb block of claim 1, wherein the first attachment side of the jamb block defines a trapezoid.

5. The jamb block of claim 1, further comprising a connector adapted to releasably attach the first attachment side of the jamb block to the first side of the furnace doorway in a first position, and adapted to releasably attach the first attachment side of the jamb block to the second side of the furnace doorway in a second position.

6. The jamb block of claim 5, wherein the connector comprises a bolt and nut, the bolt having a head embedded in the first attachment side of the jamb block.

7. The jamb block of claim 1, further comprising a cavity on the first attachment side, the cavity configured to receive a protrusion on the first side of the doorway when the jamb block is attached to the first side of the doorway.

8. The jamb block of claim 7, wherein the cavity comprises a through bore, the through bore having a first end on the first attachment side of the jamb block and a second end on a second attachment side opposite the first attachment side, the through bore configured such that either end of the through bore can receive the protrusion when the jamb block is attached to the first side of the doorway.

9. The jamb block of claim 1, further comprising a protrusion on the first attachment side, the protrusion configured to mate with a cavity on the first side of the doorway when the jamb block is attached to the first side of the doorway.

10. The jamb block of claim 1, wherein the attachment side is configured to interlock with the first side of the doorway in a first position, and configured to interlock with the second side of the doorway in a second position.

11. A reversible jamb block for a furnace having a doorway with a first side and a second side opposite the first side, the jamb block comprising:
a. a first attachment side adapted to removably attach to the first side of the doorway;
b. a second attachment side opposite the first attachment side, the second attachment side adapted to removably attach to the first side of the doorway;
d. a first face that is directed away from the furnace when the first attachment side of the jamb block is attached to the first side of the doorway; and
e. a second face opposite the first face, the second face directed away from the furnace when the second attachment side of the jamb block is attached to the first side of the doorway.

12. The jamb block of claim 11, wherein the first attachment side is adapted to removably attach to the second side of the doorway.

13. The jamb block of claim 11, wherein the second attachment side is adapted to removably attach to the second side of the doorway.

14. The jamb block of claim 11, wherein the first face of the jamb block is configured to receive a first edge of a door when the first attachment side of the jamb block is attached to the first side of the doorway, and wherein the second face is also configured to receive the first edge of the door when the second attachment side of the jamb block is attached to the first side of the doorway.

15. The jamb block of claim 11, wherein said jamb block is bilaterally symmetric.

16. The jamb block of claim 11, wherein the first attachment side of the jamb block defines a trapezoid.

17. The jamb block of claim 11, further comprising a connector adapted to releasably secure the jamb block to the first side of the furnace doorway.

18. A method of use for a jamb block to a furnace having a doorway with a first side and a second side opposite the first side, the method comprising the steps:
a. forming a jamb block comprising vertical axis and a first attachment side adapted to removably attach to a first side of the doorway, the first attachment side further adapted to removably attach to the second side of the doorway;
b. configuring the jamb block to comprise a first face that is directed away from the furnace when the first attachment side of the jamb block is attached to the first side of the doorway;
c. configuring the jamb block to have a second face opposite the first face, the second face being directed away from the furnace when the first side of the jamb block is attached to the second side of the doorway;
d. removably attaching the jamb block to the first side of the doorway;
e. removing the jamb block from the first side of the doorway;
f. rotating the jamb block 180 degrees about the vertical axis; and
g. removably attaching the jamb block to the second side of the doorway.

19. The method of claim 18, further comprising the step of configuring the jamb block to be bilaterally symmetric.

20. The method of claim 18, further comprising the step of configuring the first attachment side of the jamb block to define a trapezoid.

21. The method of claim 18, further comprising the step of releasably attaching the jamb block to the doorway with a connector.
